(19) United States
(12) Patent Application Publication
(10) Pub. No.: US 2025/0123550 A1
(43) Pub. Date: Apr. 17, 2025

(54) DISPLAY DEVICE

(71) Applicant: TOYOTA BOSHOKU KABUSHIKI KAISHA, Aichi (JP)

(72) Inventors: Daiki HARAGUCHI, Aichi (JP); Hiroyuki SUZUKI, Aichi (JP)

(73) Assignee: TOYOTA BOSHOKU KABUSHIKI KAISHA, Aichi (JP)

(21) Appl. No.: 18/888,466

(22) Filed: Sep. 18, 2024

(30) Foreign Application Priority Data
Oct. 13, 2023 (JP) 2023-177788

(51) Int. Cl. G03B 31/04; G03B 29/00

(52) U.S. Cl. CPC G03B 31/04; G03B 29/00

(57) ABSTRACT

A display device includes a first plate material on which a movie is to be projected onto a projection surface thereof, a vibrator fixed to a reverse surface of the first plate material and configured to vibrate the first plate material to generate a sound, and a second plate material fixed to the first plate material so that an obverse surface of the second plate material faces the reverse surface of the first plate material, and the vibrator is disposed in a hole provided on the obverse surface of the second plate material.

This Nonprovisional application claims priority under 35 U.S.C. §119 on Patent Application No. 2023-177788 filed in Japan on Oct. 13, 2023, the entire contents of which are hereby incorporated by reference.

### TECHNICAL FIELD

The present disclosure relates to a display device.

### BACKGROUND ART

Patent Literature 1 discloses a vehicle speaker device configured to generate a sound by using, as a source of vibration, a vibration device fixed to an interior material inside a vehicle interior to vibrate the interior material.

### CITATION LIST

### Patent Literature

[Patent Literature 1]

Japanese Patent Application Publication Tokukai No. 2005-014793

### SUMMARY OF INVENTION

### Technical Problem

Combining a display device with the vehicle speaker device of Patent Literature 1 has enabled a sound and a movie to be outputted simultaneously. However, the sound and the movie are produced independently, resulting in poor synchronization between them.

It is an object of an aspect of the present disclosure to achieve performance of a production with synchronized sound and movie.

### Solution to Problem

In order to solve the foregoing problem, a display device in accordance with an aspect of the present disclosure includes: a first plate material which has a projection surface on an obverse side thereof and on which a movie is to be projected onto the projection surface from a projection device provided inside a moving body; a vibrator fixed to a reverse surface of the first plate material and configured to vibrate the first plate material to generate a sound; and a second plate material fixed to the first plate material so that an obverse surface of the second plate material faces the reverse surface of the first plate material, a hole being provided on the obverse surface of the second plate material, the vibrator being disposed inside the hole.

### Advantageous Effects of Invention

An aspect of the present disclosure makes it possible to perform a production with synchronized sound and movie.

### BRIEF DESCRIPTION OF DRAWINGS

FIG. 1 is a view illustrating an internal configuration of a moving body mounted with a display device in accordance with an embodiment of the present disclosure.

FIG. 2 is a plan view illustrating a display device in accordance with an embodiment of the present disclosure.

FIG. 3 is a cross-sectional view taken along line A-A of FIG. 2.

### DESCRIPTION OF EMBODIMENTS

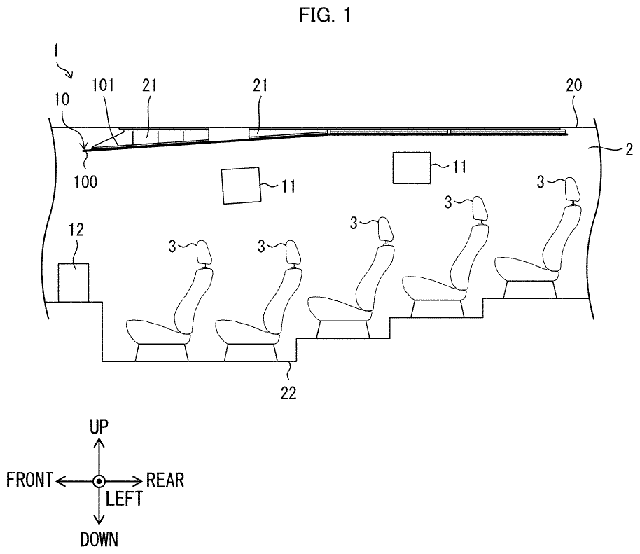

FIG. 1 is a view illustrating an example of an internal configuration of a moving body mounted with a display device in accordance with an embodiment of the present disclosure. In FIG. 1, a display device 10 in accordance with an embodiment of the present disclosure is provided along a ceiling 20 of a cabin 2 of a moving body 1. In the example illustrated in FIG. 1, the moving body 1 is a bus, provided with a plurality of seats 3 disposed along a floor surface 22. The moving body 1 provided with the display device 10 is not limited to a bus, and may be, for example, a vehicle such as an automobile, a train, a ship, an aircraft, or a spacecraft. Hereinafter, a front-and-rear direction, a left-and-right direction, and an up-and-down direction are defined as indicated by the arrows in FIG. 1.

In the cabin 2 of the moving body 1, the display device 10, a projection device 11, and a control device 12 are disposed. For example, the projection device 11 is disposed on an inner side surface of the cabin 2. Examples of the control device 12 include an electronic control unit (ECU). The control device 12 can communicate with the display device 10 and the projection device 11 in a wired or wireless manner and controls the display device 10 and the projection device 11. The control device 12 is disposed in the vicinity of a driver seat located on a front side of the moving body 1. Note that the position where the control device 12 is disposed is not limited to the position illustrated in FIG. 1. The control device 12 may be disposed in the attic space of the ceiling 20, under the floor surface 22, or inside the projection device 11, and alternatively, may be disposed outside the moving body 1.

The display device 10 includes a projection surface 100 and a connection surface 101. The projection surface 100 of the display device 10 is located on an obverse side of the display device 10 and is disposed so as to face the seats 3. The control device 12 carries out control to cause a movie to be projected from the projection device 11 onto the projection surface 100.

The connection surface 101 is located on a reverse side of the projection surface 100. A connection part 21 is coupled to the connection surface 101. The display device 10 is coupled to the ceiling 20 of the cabin 2 via the connection part 21.

In FIG. 1, the floor surface 22 rises in height toward a rear side, and the seats 3 disposed on the floor surface 22 are installed accordingly at higher positions toward a rear side. The projection surface 100 of the display device 10 is disposed at a higher position toward a rear side according to the heights at which the seats 3 are installed. In the following descriptions, it is assumed that the seats 3 are disposed in the cabin 2 in five rows in the front-and-rear direction and in two rows in the left-and-right direction.

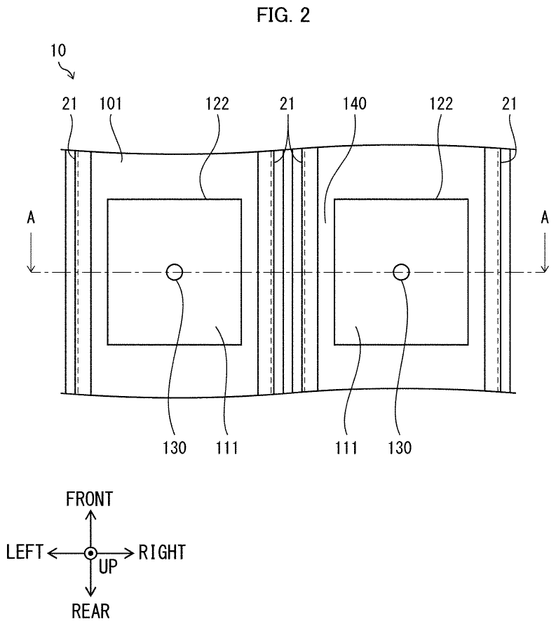

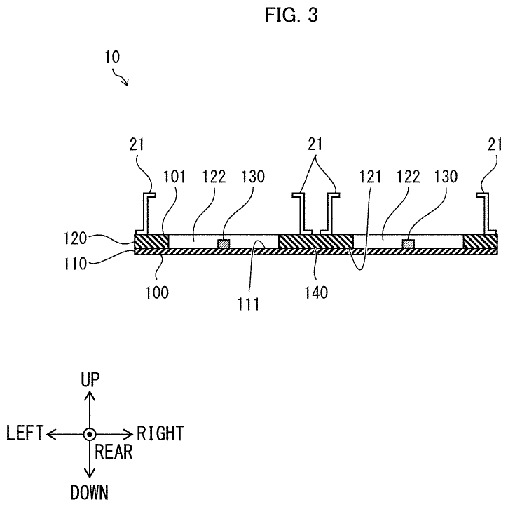

FIG. 2 is a plan view illustrating a display device in accordance with an embodiment of the present disclosure. Specifically, FIG. 2 is a plan view illustrating the display device 10 viewed from a connection surface 101 side. FIG. 3 is a cross-sectional view taken along line A-A of FIG. 2.

As illustrated in FIG. 3, the display device 10 includes a first plate material 110, a second plate material 120, and vibrators 130. The first plate material 110 is made from a fibrous material, such as a kenaf board. The second plate material 120 is made from a material, such as an iron plate, which has a higher capability of damping vibration than that of the material of the first plate material 110. The first plate material 110 has the projection surface 100 on the obverse surface thereof. The projection surface 100 to which, for example, a projection film is attached, has a smooth surface suitable for projection of a movie. The second plate material 120 has the connection surface 101 on the reverse surface thereof. The connection part 21 is coupled to the connection surface 101.

A reverse surface 111 of the first plate material 110 corresponds to a reverse side of the projection surface 100. An obverse surface 121 of the second plate material 120 corresponds to a reverse side of the connection surface 101. The first plate material 110 and the second plate material 120 are disposed so that the reverse surface 111 of the first plate material 110 and the obverse surface 121 of the second plate material 120 face each other.

The vibrators 130 are fixed to the reverse surface 111 of the first plate material 110. Holes 122 are provided on the obverse surface 121 of the second plate material 120. The reverse surface 111 of the first plate material 110 is fixed to the obverse surface 121 of the second plate material 120 so that the vibrators 130 are located inside the holes 122. A method for fixing the first plate material 110 and the second plate material 120 can be any method, such as adhesion or screw fitting.

As illustrated in FIG. 2, the holes 122 each have an edge having a rectangular shape. When seen in plan view, the vibrators 130 are disposed at the center positions of the edges of the holes 122. Note that the shape of the edge of each hole 122 is not limited to a rectangular shape. For example, the shape of the edge of the hole 122 may be a circular shape.

The plurality of vibrators 130 are fixed to the reverse surface 111 of the first plate material 110. For example, the vibrators 130 equal in number to the seats 3 disposed on the floor surface 22 of the cabin 2 may be fixed to the reverse surface 111 of the first plate material 110.

The second plate material 120 is provided with the plurality of holes 122 thereon which correspond to the plurality of vibrators 130. The plurality of holes 122 are provided so that their edges do not overlap each other when seen in plan view. The vibration restricting part 140 at which the first plate material 110 and the second plate material 120 are integrally fixed is provided between the plurality of holes 122.

Each of the vibrators 130 vibrates the first plate material 110 in out-of-plane directions thereof on the basis of an input from the control device 12 to generate a sound. One of the out-of-plane directions of the first plate material 110 faces the seats 3. Each vibrator 130 mainly vibrates an area of the first plate material 110 which is surrounded by an edge of a hole 122 corresponding to the vibrator 130. For example, the vibrators 130 generate bending vibrations in the first plate material 110. The bending vibrations generated by the vibrators 130 are damped by the vibration restricting part 140. Therefore, even in a case where the plurality of vibrators 130 are fixed to the first plate material 110, the bending vibrations generated by the plurality of vibrators 130 do not interfere with each other.

The connection part 21 is coupled to the vibration restricting part 140 of the display device 10. Depending on a method for coupling the connection part 21 to the vibration restricting part 140, it is possible to improve the capability of damping the bending vibration by the vibration restricting part 140.

The control device 12 may cause a movie to be projected from the projection device 11 onto the projection surface 100 of the display device 10 and cause the vibrators 130 to generate vibrations according to the movie. For example, the control device 12 may perform a production in which a movie projected on the projection surface 100 is vibrated by the vibrations generated by the vibrators 130. The control device 12 also may perform a production in which a sound according to the movie projected on the projection surface 100 is generated by the vibrations generated by the vibrators 130.

### Effects

As described above, the display device 10 in accordance with the present embodiment provides the following effects.

The display device 10 includes the first plate material 110, the vibrators 130, and the second plate material 120. A movie is projected onto the projection surface 100 provided on the obverse side of the first plate material 110 from the projection device 11 provided inside the moving body 1. The vibrators 130 are fixed to the reverse surface 111 of the first plate material 110, and vibrates the first plate material 110 to generate a sound. The second plate material 120 is fixed to the first plate material 110 so that the obverse surface 121 of the second plate material 120 faces the reverse surface 111 of the first plate material 110. The holes 122 are provided on the obverse surface 121 of the second plate material 120, and the vibrators 130 are disposed inside the holes 122. According to the above configuration, the first plate material 110 having the projection surface 100 is vibrated to generate a sound. Generation of a sound from a surface on which a movie is being projected enables a production with synchronized sound and movie to be performed.

The display device 10 is provided with the plurality of vibrators 130 disposed on the reverse surface 111 of the first plate material 110. The second plate material 120 is provided with the plurality of holes 122 thereon which correspond to the plurality of vibrators 130. The edges of the plurality of holes 122 do not overlap each other when seen in plan view. Between the plurality of holes 122, the vibration restricting part 140 at which the second plate material 120 is fixed to the first plate material 110 is provided. According to the above configuration in which the plurality of holes 122 are disposed so that their edges do not overlap each other and the vibration restricting part 140 is provided between the plurality of holes 122, it is possible to inhibit the vibrations generated by the plurality of vibrators 130 from interfering with each other.

In the display device 10, the second plate material 120 is made from a material having a higher capability of damping vibration than that of the first plate material 110. For example, the second plate material 120 is made from an iron plate, and the first plate material 110 is made from a fibrous material. According to the above configuration, the vibration restricting part 140 at which the second plate material 120 is fixed to the first plate material 110 has a high vibration damping capability, and thus makes it possible to inhibit the vibrations generated by the plurality of vibrators 130 from interfering with each other.

In the display device 10, the projection surface 100 faces the seats 3 which are provided in the moving body 1 and on which passengers are to be seated, and one of the out-of-plane directions of the first plate material 110 having the projection surface 100 also faces the seats 3. Therefore, it is possible to clearly output both a sound and a movie toward the passengers.

The vibrators 130 of the display device 10 generate, in the first plate material 110, vibrations according to an input from the control device 12 configured to carry out control to cause the projection device 11 to project a movie. According to the above configuration, the single control device carries out the control over the sound and the movie, and thus it is possible to easily perform a production with synchronized sound and movie.

### Variations

In the above embodiment, the display device 10 is provided with the plurality of vibrators 130 fixed to the reverse surface 111 of the first plate material 110. However, the number of the vibrators 130 fixed to the reverse surface 111 of the first plate material 110 may be one. It is also possible that the display devices 10 each provided with one vibrator 130 are disposed for the respective seats 3 of the moving body 1.

In the above embodiment, the first plate material 110 is described as a single plate material, but the first plate material 110 may be divided into a plurality of portions. For example, the first plate material 110 may be divided into a plurality of portions so as to match with the shape of the ceiling 20 of the cabin 2 or may be divided into a plurality of portions for the respective vibrators 130 fixed to the reverse surface 111. The plurality of portions constituting the first plate material 110 may be disposed with a gap between the portions. This makes it possible to inhibit the vibration generated by each portion from interfering with the vibration generated by another portion. In the above embodiment, the second plate material 120 is described as a single plate material, but the second plate material 120 may be divided into a plurality of portions. For example, the second plate material 120 may be divided into a plurality of portions so as to match with the shape of the ceiling 20 of the cabin 2 or may be divided into a plurality of portions for the respective holes 122 provided on the obverse surface 121. The plurality of portions constituting the second plate material 120 may be disposed with a gap between the portions. This makes it possible to inhibit the vibration generated by each portion from interfering with the vibration generated by another portion. Only one of the first plate material 110 and the second plate material 120 may be divided into a plurality of portions, or both of them may be divided into a plurality of portions.

In the above embodiment, the display device 10 is coupled to the ceiling 20 of the cabin 2 via the connection part 21. However, a part to which the display device 10 is coupled is not limited to the ceiling 20 of the cabin 2. For example, the display device 10 may be coupled to, for example, a seat 3, an inner side surface of the cabin 2, or the floor surface 22. The display device 10 may be coupled to the ceiling 20 without the connection part 21 interposed therebetween. For example, in a case where the ceiling 20 of the cabin 2 has a stepped shape, the display device 10 may be directly coupled to each step of the ceiling 20.

In the embodiment, the holes 122 provided on the second plate material 120 penetrate through from the obverse surface 121 of the second plate material 120 to the connection surface 101. However, the holes 122 do not need to penetrate through, provided that the holes 122 each have a volume enough to accommodate the vibrator 130 therein. A sound absorption structure may be provided on a side facing the ceiling 20 among the out-of-plane directions of the first plate material 110 to suppress travelling-around of a sound.

The present disclosure is not limited to the embodiments above, but can be altered in a various ways by a skilled person in the art within the scope of the claims. The present disclosure also encompasses, in its technical scope, any embodiment derived by combining technical means disclosed in differing embodiments as appropriate.

Aspects of the present invention can also be expressed as follows:

A display device in accordance with Aspect 1 of the present disclosure includes: a first plate material which has a projection surface on an obverse side thereof and on which a movie is to be projected onto the projection surface from a projection device provided inside a moving body; a vibrator fixed to a reverse surface of the first plate material and configured to vibrate the first plate material to generate a sound; and a second plate material fixed to the first plate material so that an obverse surface of the second plate material faces the reverse surface of the first plate material, a hole being provided on the obverse surface of the second plate material, the vibrator being disposed inside the hole.

A display device in accordance with Aspect 2 of the present disclosure is configured, in the display device in accordance with Aspect 1 above, such that: the vibrator includes a plurality of vibrators; the hole includes a plurality of holes; the plurality of vibrators are disposed on the reverse surface of the first plate material; the plurality of holes corresponding to the plurality of vibrators are provided on the second plate material; edges of the plurality of holes do not overlap each other when seen in plan view; and a vibration restricting part at which the second plate material is fixed to the first plate material is provided between the plurality of holes.

A display device in accordance with Aspect 3

of the present disclosure is configured, in the display device in accordance with Aspect 2 above, such that the second plate material is made from a material having a higher capability of damping vibration than that of the first plate material.

A display device in accordance with Aspect 4 of the present disclosure is configured, in any one of Aspects 1 to 3 above, such that: the projection surface faces a seat which is provided in the moving body and on which a passenger is to be seated; and one of out-of-plane directions of the first plate material vibrated by the vibrator faces the seat.

A display device in accordance with Aspect 5 of the present disclosure is configured, in any one of Aspects 1 to 4 above, such that the vibrator generates, in the first plate material, vibration according to an input from a control device configured to carry out control to cause the projection device to project a movie.

### REFERENCE SIGNS LIST

1 Moving body
3 Seat
10 Display device
11 Projection device
12 Control device
100 Projection surface
101 Connection surface
110 First plate material
111 Reverse surface
120 Second plate material
121 Obverse surface
122 Hole
130 Vibrator
140 Vibration restricting part

1. A display device comprising:
a first plate material which has a projection surface on an obverse side thereof and on which a movie is to be projected onto the projection surface from a projection device provided inside a moving body;
a vibrator fixed to a reverse surface of the first plate material and configured to vibrate the first plate material to generate a sound; and
a second plate material fixed to the first plate material so that an obverse surface of the second plate material faces the reverse surface of the first plate material,
a hole being provided on the obverse surface of the second plate material,
the vibrator being disposed inside the hole.

2. The display device according to claim 1, wherein:
the vibrator includes a plurality of vibrators;
the hole includes a plurality of holes;
the plurality of vibrators are disposed on the reverse surface of the first plate material;
the plurality of holes corresponding to the plurality of vibrators are provided on the second plate material;
edges of the plurality of holes do not overlap each other when seen in plan view; and
a vibration restricting part at which the second plate material is fixed to the first plate material is provided between the plurality of holes.

3. The display device according to claim 2, wherein the second plate material is made from a material having a higher capability of damping vibration than that of the first plate material.

4. The display device according to claim 1, wherein:
the projection surface faces a seat which is provided in the moving body and on which a passenger is to be seated; and
one of out-of-plane directions of the first plate material vibrated by the vibrator faces the seat.

5. The display device according to claim 1, wherein the vibrator generates, in the first plate material, vibration according to an input from a control device configured to carry out control to cause the projection device to project a movie.
